(19) United States
(12) Patent Application Publication
(10) Pub. No.: US 2010/0293810 A1
(43) Pub. Date: Nov. 25, 2010

(54) Apparatus and Method for Drying a Substrate

(76) Inventors: Mike Wallis, Corralitos, CA (US); Sean Harbison, Los Gatos, CA (US); John McEntee, Boulder Creek, CA (US)

Correspondence Address: MARTINE PENILLA & GENCARELLA, LLP, 710 LAKEWAY DRIVE, SUITE 200, SUNNYVALE, CA, 94085, US

(21) Appl. No.: 12/850,541

(22) Filed: Aug. 4, 2010

Related U.S. Application Data
(63) Continuation of application No. 11/531,905, filed on Sep. 14, 2006.

(51) Int. Cl. F26B 19/00; F26B 25/00

(52) U.S. Cl. 34/487; 34/236

(57) ABSTRACT

A method for drying a work piece is provided. The method includes raising a plurality of submerged workpieces supported on a first transition arm partially above a fluid/air interface and capturing the plurality of partially submerged workpieces during the raising by a second transition arm located above the fluid/air interface. A system for drying a workpiece is also included.

### CLAIM OF PRIORITY

This application is a continuation application of and claims priority from U.S. patent application Ser. No. 11/531,905 filed on Sep. 14, 2006. The disclosure of this related application is incorporated herein by reference for all purposes.

### BACKGROUND

In many manufacturing processes for semiconductor and magnetic disk manufacturing, it is necessary to treat a work piece in a liquid environment and then dry the work piece. As is well known, particulates or contaminates that attach during the drying process may eventually cause defects in the work piece. In addition, inefficient drying may not only add to the processing time, but may also leave defects on a surface of the work piece, as well as promote oxidation. Thus, it is extremely important that when a substrate is dried, there are no impurities left on its surface. In addition, during the drying process, a wafer holding mechanism is in contact with the wafer/work piece. One of the defects sometimes left during the drying process is a drying mark at a point of contact where a wafer/work piece is held during drying. In order to eliminate this defect, the embodiments described below provide a dual handoff mechanism for efficiently drying a semiconductor manufacturing work piece.

### SUMMARY

Embodiments of the present invention provide a system and method for drying a substrate efficiently. It should be appreciated that the present invention can be implemented in numerous ways, such as a process, an apparatus, a system, a device or a method. Several inventive embodiments of the present invention are described below.

In one embodiment, a system for drying a work piece is provided. The system includes a chamber containing a cleaning fluid in a first portion of the chamber and a drying region in a second portion of the chamber. The system also includes a wet transition arm configured to support a plurality of work pieces while disposed in the cleaning fluid. A dry transition arm configured to accept the plurality of work pieces from the wet transition arm as the wet transition arm is being raised towards an interface of the cleaning fluid and the drying region is also included. The dry transition arm and the wet transition arm are coupled to a common drive mechanism, wherein the common drive mechanism includes a first and a second motor. The first motor is configured to drive both the wet transition arm and the dry transition arm and the second motor is configured to control an amount of separation between the wet transition arm and the dry transition arm.

In another embodiment, a transition arm for transporting work pieces is provided. The transition arm includes a first and second bellows and a bellows crank moveably attached to both the first and second bellows. The bellows crank has first and second extensions extending therefrom. The transition arm further includes first and second torque rods pivotably coupled to the bellows crank where the first and second torque rods are coupled to respective first and second extension arms. The first and second torque rods support corresponding first and second extension arms, wherein expansion of the first bellows causes the first and second extensions of the bellows crank to impart rotational movement to the first and second torque rod, thereby causing a bottom portion of first and second extension arms to move away from each other.

In yet another embodiment, a method for drying a work piece is provided. The method initiates with transferring a plurality of work pieces from a horizontal transport to a first transition arm and lowering the first transition arm into a bottom portion of a tank of cleaning fluid. The method includes raising the first transition arm from the bottom portion of the tank to a cleaning fluid/air interface. While raising the first transition arm, a gap between a pair of extensions on a second transition arm located above the cleaning fluid air interface is expanded. The gap between the pair of extensions is partially closed after a mid line region of the work piece has raised above a bottom portion of the pair of arms. The second transition arm is raised faster than the first transition arm to lift the plurality of work pieces from the first transition arm.

Other aspects of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1A is a simplified schematic diagram illustrating a dual handoff drying system in accordance with one embodiment of the invention.

FIG. 1B is a simplified schematic diagram of the system of FIG. 1A illustrating the transition of the work piece from a wet condition to a dry condition in accordance with one embodiment of the invention.

FIG. 1C is a simplified schematic illustrating a work piece being transitioned completely into the dry region of a chamber in accordance with one embodiment of the invention.

FIG. 1D is a simplified schematic diagram illustrating a cross section of a side view of the chamber when the work piece is in an elevated position in accordance with one embodiment of the invention.

FIG. 2 is a simplified schematic diagram illustrating an overview of a drying system having a wet transition support and a dry transition support for processing a work piece in accordance with one embodiment of the invention.

FIG. 3A is a simplified schematic diagram illustrating a perspective view of the drive mechanism for the supports for the system of FIG. 2 in accordance with one embodiment of the invention.

FIG. 3B is a simplified schematic diagram illustrating a change in the separation between wet transition support and dry transition support as compared to FIG. 3A.

FIG. 4A is a simplified schematic diagram illustrating an overview of the system for drying a work piece in accordance with one embodiment of the invention.

FIG. 4B is a simplified schematic diagram illustrating the system of FIG. 4A with the transition supports in a lowered position.

FIG. 5A is a simplified schematic diagram illustrating a side perspective view of the dry transition support in accordance with one embodiment of the invention.

FIG. 5B illustrates a front perspective view of a dry transition support in accordance with one embodiment of the invention.

FIG. 5C is a back perspective view of a dry transition support in accordance with one embodiment of the invention.

### DETAILED DESCRIPTION

The embodiments described herein provide a system and method for processing a substrate for manufacturing operations. It will be obvious, however, to one skilled in the art, that the present invention may be practiced without some or all of these specific details. In other instances, well known process operations have not been described in detail in order not to unnecessarily obscure the present invention.

The embodiments described below describe a system and apparatus for drying a work piece after processing operations. In one embodiment, the system is used to dry magnetic disks that stores data thereon. It should be appreciated that the embodiments are not limited to drying magnetic disks as any semiconductor circuit device, flat panel display, or other substrate needing handling, may be dried by the embodiments described herein. The term work piece as used herein may refer to any substrate being processed. The system provides a support or nest that stays wet and another support or nest that remains dry. In one embodiment, a transition nest/support is included that crosses the wet/dry interface. The dry support has arm extensions that are pivotably mounted so that each arm extension may extend about a pivot point outward and inward to facilitate grasping the work piece. The dry support arm grasps the substrate as the wet support arm lifts the work piece out of a bath. The dry support arm grasps the work piece by dropping down from an overhead position and while dropping down, extends the arm extensions to grasp the work piece below a mid-line of the work piece. The extension arms are brought back closer together and the carriage supporting the dry support arm is raised upwards, thereby causing a bottom surface of each of the extension arms to contact the work piece. The work piece is then transferred from the wet support arm to the dry support arm.

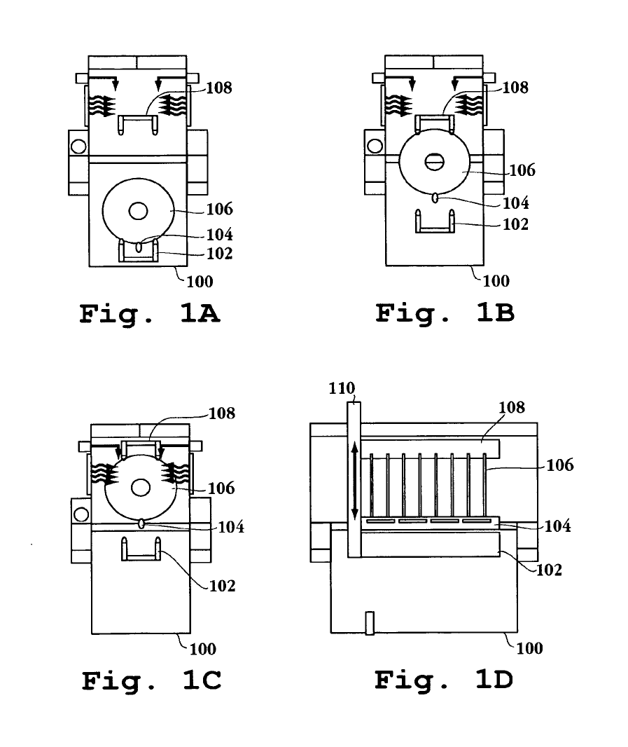

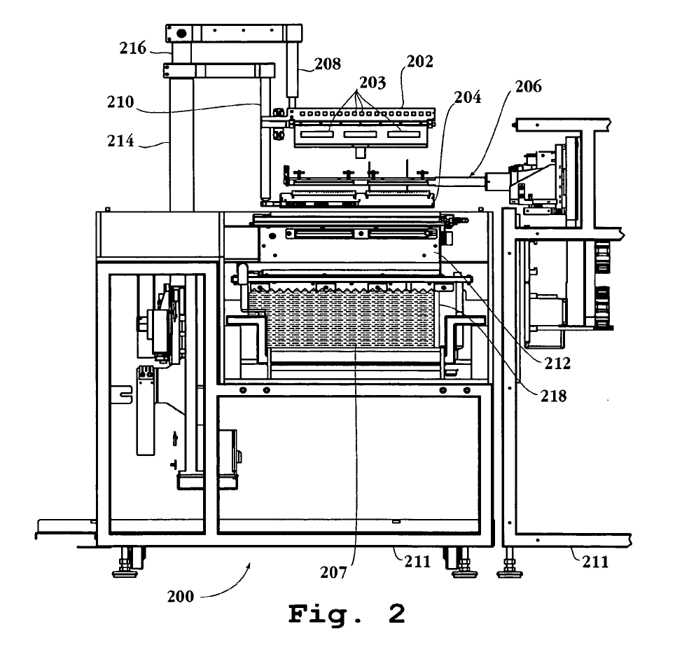

FIG. 1A is a simplified schematic diagram illustrating a dual handoff drying system in accordance with one embodiment of the invention. Dryer 100 includes a tank containing a fluid in which work piece 106 is immersed. One skilled in the art will appreciate that the fluid may be a cleaning fluid commonly used for cleaning magnetic disks, integrated circuits, or flat panel displays. Work piece 106 is supported by a wet nest 102 and a transition nest 104, which together define a lower nest to support the work piece in the cleaning fluid. Wet nest 102 and transition nest 104 support the weight of work piece 106 when the work piece is submerged in the cleaning fluid. As illustrated, three contact points are provided in order to support work piece 106. In one embodiment, the contact points are a knife edge to minimize the area of contact with work piece 106, however, any suitable shape may be applied for the contact points with the work piece. One skilled in the art will appreciate that while one work piece is illustrated here, a plurality of work pieces are typically being processed at one time as illustrated with reference to FIG. 1D.

FIG. 1B is a simplified schematic diagram of the system of FIG. 1A illustrating the transition of the work piece from a wet condition to a dry condition in accordance with one embodiment of the invention. As illustrated in FIG. 1B, wet nest 102 is partially raised and transitioned from a wet state to a dry state. At a certain point while the work piece is submerged, transition nest 104 separates or disengages from wet nest 102 and provides the support to raise work piece 106 to come into contact with dry nest 108. Once dry nest 108 is in contact with work piece 106, dry nest 108 provides alignment previously provided when wet nest 102 was engaged with the work piece. Transition nest 104 supports the weight of work piece 106. In one embodiment, transition nest 104 includes a number of knife edged or large angled air flow slots to support work piece 106. In addition, the transition nest structure supports wicking. In FIG. 1C, work piece 106 is transitioned completely into the dry region of chamber 100. Thus, transition nest 104 and dry nest 108 are now outside of the liquid within chamber 100. It should be appreciated that as the work piece resides in the dry region of chamber 100, air flow is provided to enhance the drying of the work piece 106. In one embodiment, nitrogen is provided at an air flow of 15 to 20 cubic feet per minute from a top region of chamber 100 and exits through the side regions above the liquid air interface within the chamber. In another embodiment, the nitrogen is heated above ambient temperature for the drying. It should be appreciated that any inert gas may be applied to enhance the drying process and that the embodiments are not restricted to the use of nitrogen.

FIG. 1D is a simplified schematic diagram illustrating a cross section of a side view of the chamber when the work piece is in an elevated position in accordance with one embodiment of the invention. As shown, wet nest 102 is within the fluid portion of chamber 100 and disengaged from transition nest 104, while transition nest 104 and dry nest 108, which are supporting work piece 106 are in the dry region of chamber 100. It should be appreciated that the separation between wet nest 102 and transition nest 104 may be accomplished through the use of a motor driving a lead screw. Arm 110 is used to support wet nest 102, transition nest 104, and dry nest 106 through the use of separate concentric tubes within arm 110 in one embodiment. It should be noted that with reference to FIGS. 1B and 1C, once a degree of separation is provided between wet nest 102 and transition nest 104, this separation may remain constant as illustrated in FIG. 1C and thereafter the transition nest may be lowered to re-engage with the wet nest. One skilled in the art will appreciate that commonly available mechanical techniques, e.g., through the use of mechanical stops, etc., may be employed to achieve this functionality.

FIG. 2 is a simplified schematic diagram illustrating an overview of a drying system having a wet transition support and a dry transition support for processing a work piece in accordance with one embodiment of the invention. System 200 includes dry transition support 202, horizontal transition device 206 and wet transition support 204. System 200 incorporates chamber 218, which includes tank 207 and drying region 212. One skilled in the art will appreciate that the system diagram of FIG. 2 is being illustrated with the dry transition support 202 and wet transition support 204 out of chamber 218 for illustrative purposes. Chamber 218 contains a cleaning fluid which can be any suitable cleaning fluid, including de-ionized water, used in the manufacture of semiconductor substrates, magnetic disks, flat panel displays, etc.

Still referring to FIG. 2, dry transition support 202 is coupled to carriage support 208, which is connected to inner tube 216. Wet transition support 204 is coupled to carriage 210, which is connected to outer tube 214. It should be appreciated that outer tube 214 and inner tube 216 are two concentric tubes which can move independently from each other or in conjunction with each other according to the configuration of the drive mechanism. Thus, outer tube 214 and inner tube 216 may have independent motors driving each of the corresponding tubes or a common motor may drive the two tubes, and commonly known drive mechanisms may be employed to achieve the functionality/timing for the operation of wet transition support 204 and dry transition support 202. Dry transition support 202 is also coupled to carriage 210 in order to synchronize with the wet transition support 204 for the transition of work pieces. Horizontal transition mechanism 206 functions to remove work pieces after processing and provide work pieces prior to processing. After processing, dry transition support 202 will place the work pieces onto horizontal transition mechanism 206. Prior to processing, wet transition support 204 receives the work pieces from horizontal transition mechanism 206. Chamber 218 is further configured to enable enhanced airflow within drying region 212 for the drying process. In one embodiment, nitrogen which may or may not be heated is provided from a top region of chamber 218 and exits through a lower portion of a side of drying region 212. In another embodiment, dry transition support 202 contains perforations 203 to further enhance the airflow while the work pieces are being held within the dry transition support. It should be noted that perforations 203 are optional. Frame 211 supports the various mechanical features described herein. One skilled in the art will appreciate that a controller may be used to control the movement of the mechanical arms and the timing of the sequence of operations discussed herein. In addition, the embodiments are not limited to the two concentric tubes for moving the corresponding carriage supports, as other commonly know drive mechanisms may be substituted for the two concentric tubes.

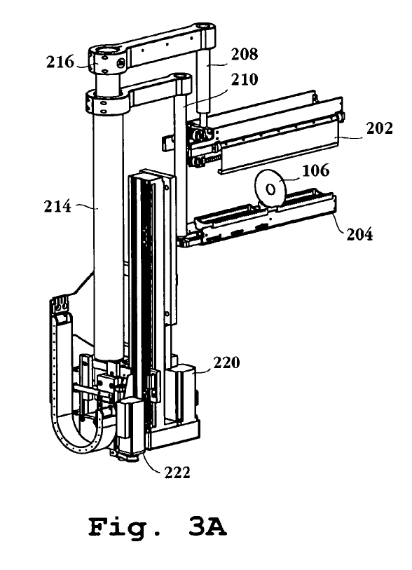

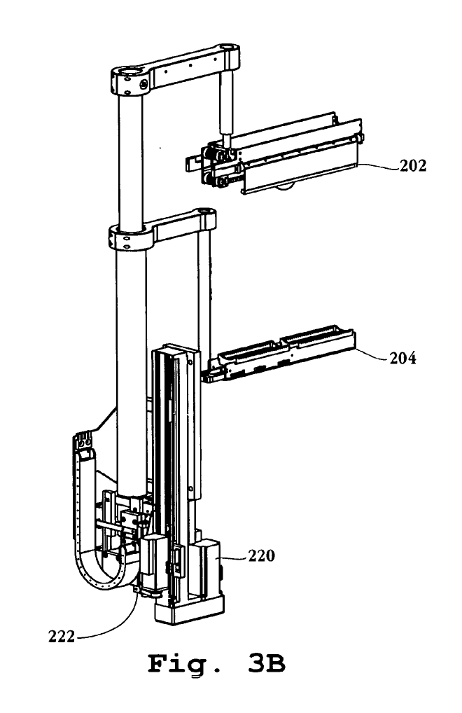

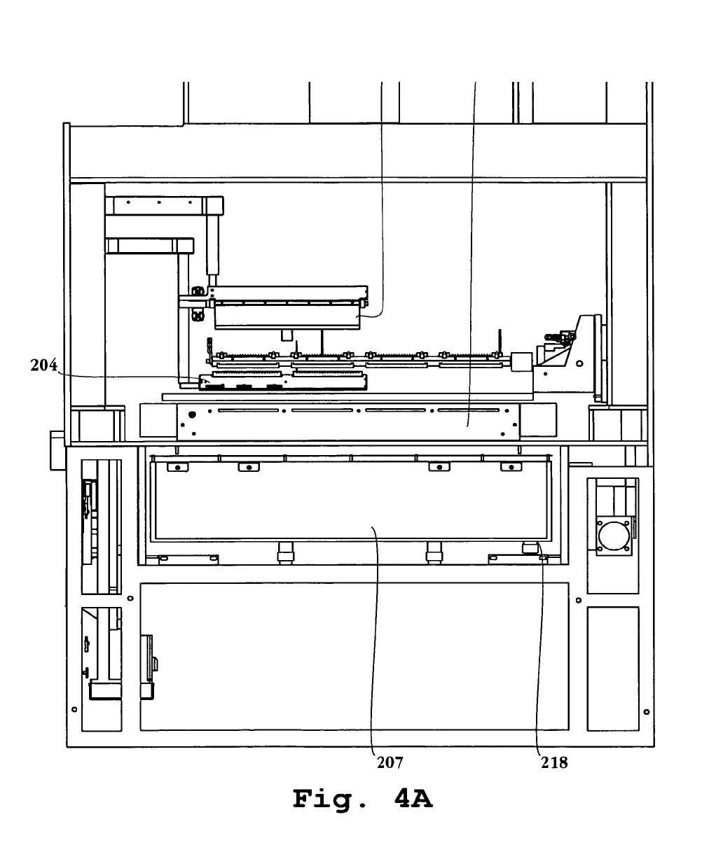

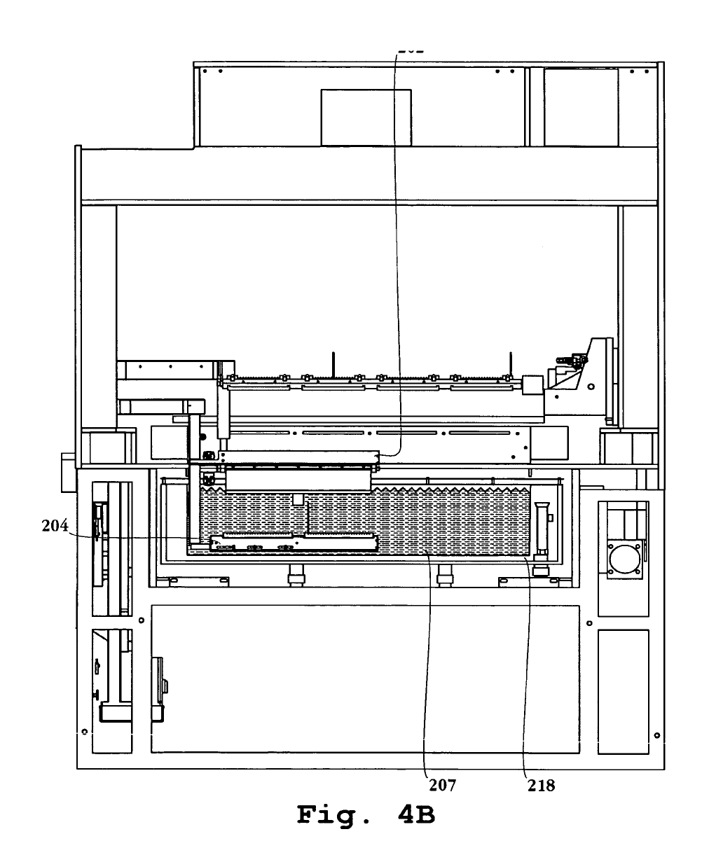

FIG. 3A is a simplified schematic diagram illustrating a perspective view of the drive mechanism for the supports for the system of FIG. 2 in accordance with one embodiment of the invention. Outer tube 214 is coupled to carriage 210, which provides support for wet transition support 204. Work piece 106 is illustrated being supported within wet transition support 204. Of course, a plurality of work pieces may be supported and a single work piece is shown here for ease of illustration. By the control of motor 220, outer tube 214 may move in a vertical motion relative to the plane of the fluid air interface within chamber 218 in order to bring wet transition support 204 within tank 207 of the system illustrated in FIG. 2. Motor 222 may be used to drive the inner tube 216 which is connected to carriage 208, which in turn supports dry transition support 202. Of course, motor 220 may be used to control the movement of both inner tube 216 and outer tube 218, while motor 222 can be configured to change the separation between wet transition support 204 and dry transition support 202 as illustrated in FIG. 3B. In FIG. 3B, motor 222 has caused a change in the separation between wet transition support 204 and dry transition support 202. It should be appreciated that this position may be used when a work piece is dwelling in the tank of the chamber as illustrated in FIG. 2.

Returning to FIG. 3A, through the vertical transition of inner tube 216, dry transition support 202 is extended in a vertical position in order to capture work pieces 106 from wet transition support 204 for further drying and movement to other processing. It should be appreciated that because dry transition support 202 never contacts the cleaning liquid there is no need to wait for the dry transition support to dry prior to coming into contact with work piece 106.

In one embodiment, a Marangoni effect promotes the rapid drying of work piece 106 as the work piece leaves the cleaning fluid. One skilled in the art will appreciate that the Marangoni effect facilitates rapid drying by slowly removing the work piece in the presence of vapor that aids in the drying process. Thus, when dry transition support engages with work piece 106, the work piece is dry at the point of engagement so that there are no water marks left on the work piece by this process.

FIG. 4A is a simplified schematic diagram illustrating an overview of the system for drying a work piece in accordance with one embodiment of the invention. In FIG. 4A, the components, i.e., wet transition support 204 and dry transition support 202, are in an up position outside of tank 207 and dry region 212 of processing chamber 218. Upon initiation of a processing sequence, wet transition support 204 loaded with work pieces, will drop down into tank 207 of processing chamber 218 as illustrated in FIG. 4B. Similarly, dry transition support 202 will drop down to a position just above a liquid air interface within processing chamber 218 in one embodiment. One skilled in the art will appreciate that any suitable cleaning technique may be applied in tank 207, e.g., megasonic cleaning, batch chemical cleaning, etc. Once the cleaning cycle has been completed, wet transition support 204 will raise the work pieces to the liquid air interface within chamber 218. Once the work pieces are above this interface, dry transition support 202 will capture the work pieces and lift the work pieces into dry region 212 of chamber 218. It should be appreciated that depending on the recipe used and the work pieces being dried, dry transition support 202 may remain in the drying region for a certain period of time prior to coming out of processing chamber 218 to place the work pieces on horizontal transport 206. Various schemes may be used to raise and lower the transition supports, e.g., speeds and pausing at certain points. Dry transition support 202 is raised at a rate of between about 0.1 millimeters (mm)/second and about 10 mm/second as wet transition support 204 rises within a similar rate range. As dry transition support 202 is raised at a faster rate relative to wet transition support 204, the dry transition support will overtake wet transition support 204 to lift the work pieces. It should be appreciated that as dry transition support 202 is lowered into position to receive or take the work piece from wet transition support 204, the dry transition support may be lowered at a rate of 100 mm/second. In addition, as dry transition support 202 has full control of the work piece and is moving the work piece to the horizontal transition mechanism, the rate of movement of the dry transition support may range between about 0.5 mm/second and 170 mm/second.

FIG. 4B is a simplified schematic diagram illustrating the system of FIG. 4A with the transition supports in a lowered position. Wet transition support 204 and dry transition support 202 are lowered through the action of a drive motor. Thus, wet transition support 204 will reside within tank 207 and dry transition support resides above the fluid air interface within chamber 218. In one embodiment, the material of construction for the parts contacting the work piece is a thermoplastic, such as Polyetheretherketon (PEEK). However it should be appreciated that any suitable material compatible with the work piece and the processing conditions may be employed with the embodiments discussed herein.

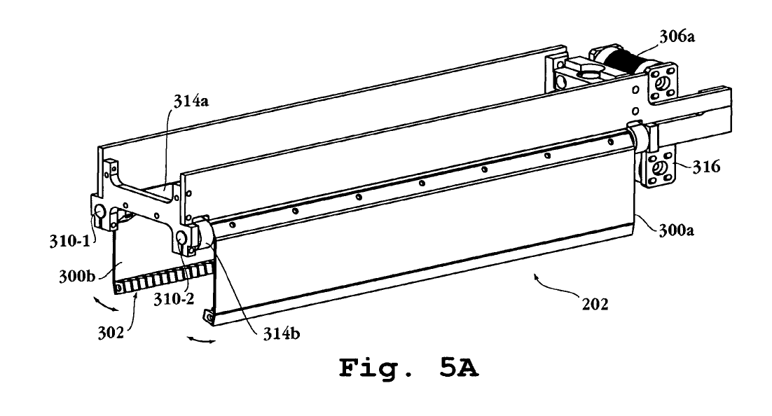

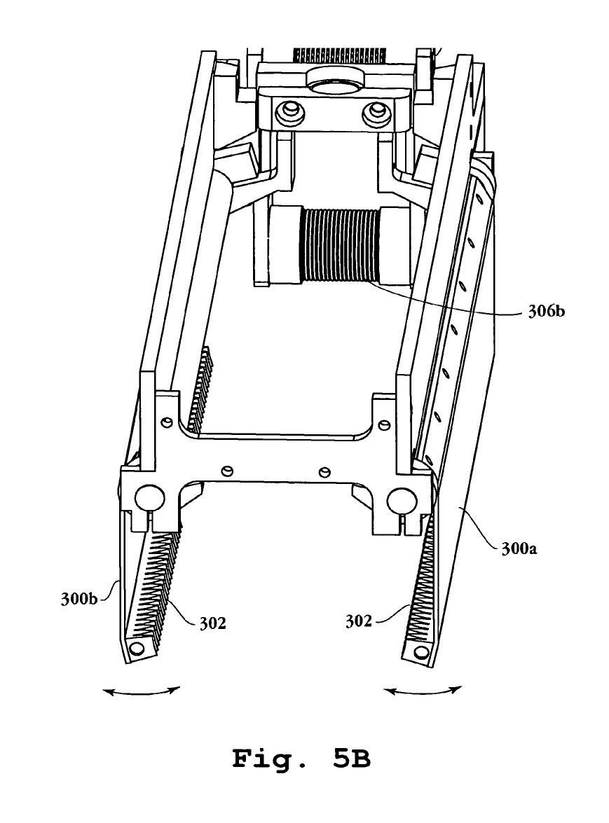

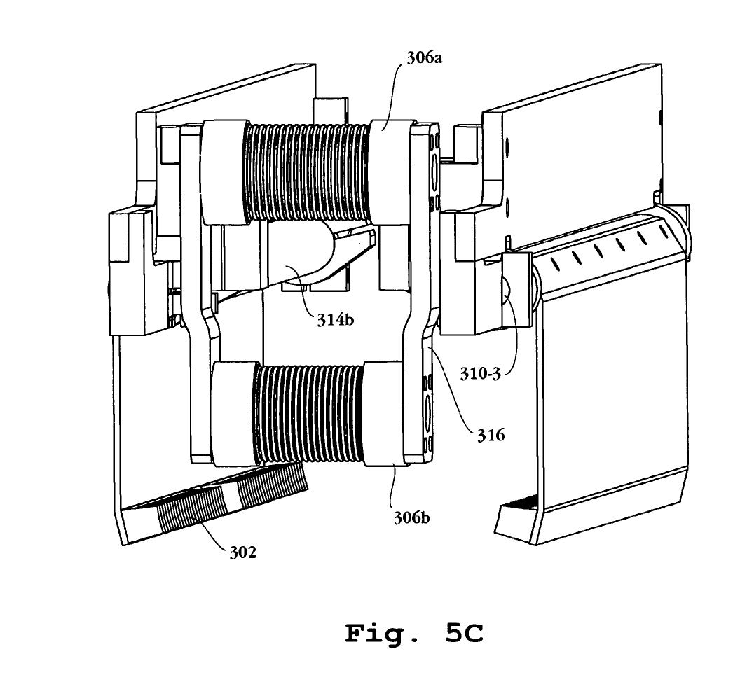

FIG. 5A is a simplified schematic diagram illustrating a side perspective view of dry transition support 202 in accordance with one embodiment of the invention. Dry transition support 202 includes two arms 300a and 300b having comb support 302 at the bottom of each of the two arms in order to support the work pieces lifted from the wet transition support. Torque rods 314a and 314b extend from each top end of the two support arms, i.e., the torque rods are opposing comb supports 302. Dry transition support 202 also includes bellows 306a and 306b, which are better illustrated with regard to FIG. 5B, which is a top view of dry transition support 202. It should be apparent to one skilled in the art that while comb support 302 is defined as having a plurality of knife edged protrusions for supporting the work pieces, any shape may be used for the protrusions. It is preferable to define a shape that minimizes the contact area between the comb support and the work piece.

Still referring to FIG. 5A, flexural pivots 310-1 and 310-2 are provided and act as a pivot point around torque rods 314a and 314b for arms 300a and 300b to move outward and inward in order to grasp the work pieces. It should be appreciated that two additional flexural pivots on opposing ends of torque rod 314a and 314b. Therefore there are a total of four flexural pivots for dry transition support 202. The flexural pivots are commercially available from C-Flex Bearing Co. of Frankfort N.Y. The flexural pivots are flexure based bearings, utilizing internal flat crossed springs, capsuled in a cylindrical housing, to provide precise rotation with low hysteresis and no frictional losses. Bellows crank 316 assists in supporting bellows 306a and 306b and translating movement initiated by bellows 306a and 306b. Arms 300a and 300b will fan in and out based on the movement initiated through bellows 306a and 306b.

FIG. 5B illustrates a front perspective view of dry transition support 202 in accordance with one embodiment of the invention. Bellows crank 316 is forced to move in response to movement by bellows 306a and 306b. In one embodiment, bellows 306a and 306b are governed as to how far they enable arms 300a and 300b to extend and contract. For example, bellows 306a and 306b may be governed to limit the expansion and contraction of arms 300a and 300b to three degrees, in one embodiment. This expansion of three degrees translates to corresponding bellows expansion/contraction of about less than 0.2 inches. In this embodiment, bellows 306a and 306b are governed to expand and contract, respectively, by less than 0.2 inches. One skilled in the art will appreciate that as there are no rotating or other moving parts which will generate contamination, the dry transition arm illustrated in FIGS. 5A through 5C provides a very clean transition technique. In another embodiment, arms 300a and 300b may be perforated in order to enhance the drying of the work pieces while captured within dry transition support 202.

FIG. 5C is a back perspective view of dry transition support 202 in accordance with one embodiment of the invention. In this view, torque rod 314b and flexure pivot 310-3 are visible. In one embodiment, bellows 306b expands to force bellows crank 316 outward in the vicinity of bellows 306b. This force is then translated through flexure pivots and imparts a rotational force to corresponding torque rods to cause arms 300a and 300b to fan out. Thus, in the fanned out position, dry transition support 202 will be able to be dropped down over the work pieces being raised by the wet transition arm. Upon dry transition support 202 being placed over the work pieces, bellows 306a expands to force bellows crank 316 outward in the vicinity of bellows 306a. This, in turn causes arms 300a and 300b to move inwards toward each other, so that dry transition arm 202 can close down to lift the work pieces from the wet transition arm. In effect, the activation of bellows 306a reverses the effect of the activation of bellows 306b. In one embodiment, the work pieces never stop moving, i.e., raising up, during the transition between transition arms. That is, the wet transition arm brings the work pieces up above the fluid interface and the dry transition arm opens up to allow the work pieces to continue to rise upwards so that a mid line of the work pieces is below comb support 302 of dry transition support 202. The arms of dry transition support 202 then close inwards and move upwards at a faster rate than the wet transition support, in order to remove the work pieces from the wet transition arm. In one embodiment, dry transition support 202 will dwell in the drying region of the chamber for a certain period of time before being moved up to deposit the work pieces to the horizontal transport.

In summary, the embodiments described herein provide a method and a system that dries a work piece in an efficient manner and without leaving any defects. In a first embodiment a lower nesting separates into a first and second portion while the work piece is being raised out of the liquid bath, i.e., as the work piece is transitioning into the drying region. Here, the second portion supports the weight of the work piece and a dry nest support contacts an upper edge of the work piece after the work piece has entered into the drying region. The dry nest support provides the stability for removal of the work piece from the cleaning bath. In another embodiment, the lower nest remains as an integral piece and the dry nest moves downward over the work piece as the lower nest is transitioning the work piece out of the cleaning bath and into the drying region. The dry nest then moves upward faster than the lower nest is moving upward to take the work piece and complete the drying cycle, while the lower nest remains in the cleaning bath.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

Although the foregoing invention has been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A method for drying a work piece, comprising method operations of:
placing a plurality of work pieces on a first transition arm;
lowering the first transition arm into a bottom portion of a tank of fluid;
raising the first transition arm from the bottom portion of the tank to a fluid/air interface;
while raising the first transition arm, expanding a gap between a pair of extensions on a second transition arm located above the fluid/air interface;
partially closing the gap between the pair of extensions after the work piece has raised above a bottom portion of the pair of extensions; and
raising the second transition arm faster than the first transition arm to lift the plurality of work pieces from the first transition arm, wherein the second transition arm and its pair of extensions remains dry.

2. The method of claim 1, wherein the method operation of expanding a gap between a pair of extensions on a second transition arm located above the fluid/air interface includes,
expanding a first bellows.

3. The method of claim 1, wherein the method operation of partially closing the gap between the pair of extensions after the work piece has raised above a bottom portion of the pair of extensions includes,
expanding a second bellows.

4. The method of claim 1, further comprising:
pausing the raising of the second transition arm after lifting the work pieces; and
transferring the plurality of work pieces to a horizontal transfer unit.

5. The method of claim 1, wherein the partially closing the gap between the pair of extensions occurs after a midline of the work piece is above a bottom portion of the pair of extensions.

6. A method for drying a work piece, comprising:
raising a plurality of submerged work pieces supported on a first transition arm partially above a fluid/air interface; and
capturing the plurality of partially submerged workpieces during the raising by a second transition arm located above the fluid/air interface.

7. The method of claim 6, wherein the first transition arm remains submerged during the capturing.

8. The method of claim 6, wherein during the capturing the first transition arm is raising at a rate slower than a rate of raising for the second transition arm.

9. The method of claim 6, further comprising:
expanding a gap between a pair of extensions on the second transition arm; and
partially closing the gap between the pair of extensions prior to the capturing.

10. The method of claim 9, wherein the partially closing the gap occurs after occurs after a midline of the work piece is above a bottom portion of the pair of extensions.

11. The method of claim 6, wherein the work pieces are circular and are supported at two points below a mid line of the work pieces by the second transition arm during the capturing.

12. The method of claim 6, wherein the second transition arm remains above the fluid/air interface.

13. The method of claim 6, further comprising:
pausing movement of the second transition arm above the fluid air interface after the capturing.

14. A method for drying a substrate, comprising:
raising a plurality of substrates submerged in a fluid and supported on a first transition arm;
transferring the plurality of substrates onto a second transition arm from the first transition arm, the transferring occurring as the first transition arm is raising, wherein the second transition arm remains above a fluid/air interface; and
capturing the plurality of substrates along an outer edge of the substrates and below a mid line of the substrates during the transferring.

15. The method of claim 14, wherein the substrates are circular and are supported in a vertical orientation by the first and second transition arm.

16. The method of claim 14, wherein the first transition arm remains submerged in the fluid during the transferring.

17. The method of claim 14, wherein during the capturing the first transition arm is raising at a rate slower than a rate of raising for the second transition arm.
